(19) United States
(12) Patent Application Publication
(10) Pub. No.: US 2003/0029674 A1
(43) Pub. Date: Feb. 13, 2003

(54) Sliding hinge seat moving method

(76) Inventor: Phillip Thomas Heath, Shelbyville, TN (US)

Correspondence Address: Phillip T. Heath, 578 Lower Halls Mill Rd., Shelbyville, TN, 37160, US

(21) Appl. No.: 10/199,347

(22) Filed: Jul. 19, 2002

Related U.S. Application Data
(60) Provisional application No. 60/310,987, filed on Aug. 9, 2001.

(51) Int. Cl. A01M 31/00

(52) U.S. Cl. 182/136; 182/187

(57) ABSTRACT

A new method of moving a non-detachable seat on a tree stand from facing toward the tree position to facing away from the tree position. The method allows the user to move the seat past his body without the removal of the seat or any parts or maneuvering to avoid the seat's movement as it is repositioned.

### CROSS REFERENCE TO RELATED APPLICATIONS

This application is a continuation of the provisional application filed on Aug. 9, 2001 application No. 60/310,987 titled “Sliding Hinge Seat” filed in my name, Phillip Heath. I hereby claim benefit of the earlier filing.

### FIELD OF THE INVENTION

The present invention is designed for use on platforms or scaffolds secured to columnar shaped objects such as a tree and are commonly referred to as “tree stands”. Tree stands are used by a person, such as a hunter or photographer, to gain and/or maintain an elevated position on a column/tree. The present invention is more specifically designed for use on climbing tree stands. The invention is not limited to climbing stands however, and can be used on fixed position stands or other applications as well. The present invention is more specifically related to the method of providing a seat for the occupant in multiple positions.

### DESCRIPTION OF PRIOR ART

Prior art provides two basic types of tree stand; the fixed position stand/platform and the climbing stand. The fixed position stand/platform requires the use of a ladder or other climbing means to gain the elevated position. The ladder or climbing device may or may not be connected to the stand and/or tree. The fixed position tree stand typically makes some provision for the occupant to be seated upon gaining the desired elevation. Examples of these are: U.S. Pat. Nos. 683,527 2,394,203 2,991,842 3,116,808 3,730,294 4,236,602 6,267,202 6,336,520.

The climbing tree stand provides a means for gripping the tree or column and alternately grasping the column to provide the climbing method to gain elevation. Those practiced in the art can appreciate the climbing method employing a lower platform with tree gripping means and an upper platform with similar gripping means. These two platforms are moved alternately to climb a tree. These platforms are commonly used to climb a tree and support a person and their equipment in the elevated position.

The invention of the preferred embodiment is specific to the climbing tree stand and prior art will be described in greater detail specific to that application. Application to the fixed position type stand should be understood to be similar. Climbing tree stands are usually designed for climbing while facing the tree. Some designs provide for climbing while facing away from the tree. Examples of stands which climb while facing away from the tree are: U.S. Pat. No. 3,960,240 to Cotton, U.S. Pat. No. 4,244,445 to Strode, and U.S. Pat. No. 5,685,393 to Early. Facing the tree while climbing offers the occupant the best view of the tree being climbed, greater control over rough tree surfaces such as limbs, bark, or vines and added safety as opposed to climbing while facing away. Facing the tree while climbing is therefore preferred.

However, sitting with your back against the tree is preferred once the desired climbing height has been achieved in order to obtain an unobstructed view of the surrounding area. Therefore, there is a need to climb facing the tree and a need to sit facing away from the tree. Because of these needs, there is also a need to have a method of providing a comfortable seat at each of these positions. Prior art has supplied various methods to meet the seating/climbing position needs. The method employed to meet the opposing needs is the subject of the present invention. Prior art methods are demonstrated by the following:

HAND CLIMBERS

This type of stand such as U.S. Pat. No. 3,955,645 to Dye, U.S. Pat. No. 4,830,143 to Fisher, and U.S. Pat. No. 5,265,780 to Matthews, provide for climbing while facing the tree but only one seating position. This type of design also requires a substantial amount of arm and upper body strength for the user to be able to lift themselves in the alternating movements required to climb. This type of stand is incapable of performing the climbing method know to those practiced in the art as the “stand-up, sit-down method” for climbing. The “stand-up, sit-down” method is advantageous since it eases the physical effort required to climb. The following examples employ the “stand-up, sit-down” method to climb but employ various methods for supplying the needed seating positions. They are grouped in reference to the seating method employed.

SINGLE SEAT METHOD

This method which is employed by the hand climbers mentioned above and other designs typically offer only one seating position usually facing away from the tree. U.S. Pat. No. 4,337,844 to Hice, and U.S. Pat. No. 5,492,198 to Williams use this method. Gibson, in U.S. Pat. No. 4,726,447, provides a single seat at the facing the tree position.

DUAL SEAT METHOD

This method provides two separate seats with one at each position. U.S. Pat. No. 4,997,063 to Bradley, U.S. Pat. No. 5,588,499 to Carriere, U.S. Pat. No. 5,862,883 to Carriere, employ this method.

DETACHABLE SEAT METHOD

This method utilizes one seat with hardware, which is detached and moved from the facing the tree position to the facing away position upon reaching the desired vantage height. This is probably the most commonly used method and is illustrated in U.S. Pat. No. 4,331,216 to Amacker, U.S. Pat. No. 5,433,291 to Shoestock, U.S. Pat. No. 5,775,464 to Gardner and U.S. Pat. No. 6,308,800 to Graham along with many others.

SLIDING SEAT METHOD

This method utilizes a single seat, which is slid from one position to another along the supporting frame rails. U.S. Pat. No. 4,969,538 to Amacker, U.S. Pat. No. 5,909,505 to Amacker, U.S. Pat. No. 5,156,236 to Gardner and U.S. Pat. No. 6,345,690 to Morris employ this method.

HINGED SEAT METHOD

This method utilizes the back of one seat to form the seat of another by pivoting it about a hinge axis to its new position.

U.S. Pat. No. 4,452,338 to Untz and U.S. Pat. No. 4,953,662 to Porter utilize this method.

PIVOTING/SWIVEL SEAT METHOD

This method uses one seat, which rotates or swivels on an axis that is centered on the seat. U.S. Pat. No. 4,488,620 to Gibson, U.S. Pat. No. 5,482,137 to McNeill, and U.S. Pat. No. 5,842,540 to Mancini employ this method.

The listed prior art solutions have the following shortcomings:

The SINGLE SEAT method does not meet the need of providing two seating positions.

The DUAL SEAT METHOD adds weight, redundancy, and decreases the usable area inside the frame members.

The DETACHABLE SEAT METHOD uses removable parts that may be dropped from the elevated position leaving the occupant with no seat. This method also requires the user to remove parts. This increases the amount the hunter must move. Any movement the hunter makes may be detected by the game being sought. Therefore it is desirable to keep these movements to a minimum.

The HINGED OR SLIDING SEAT METHODS are typically attached to both frame rails. This requires the occupant to step over or pass under the seat as it is repositioned. This creates excess movement and increases the risk of the occupant loosing his balance, which could result in a fall.

The PIVOTING SEAT METHOD requires excess weight and often requires the user to swing their legs over supporting frame members. It is also awkward to transport in the backpack configuration, which is known in the art.

Due to these and other problems an improved method for providing a seat in both positions is needed.

The prior art invention found in U.S. Pat. No. 5,101,933 to Huntley utilizes similar movements as the current invention. However, Huntley's invention is for the purpose of enabling the hunter to move the seat a confined distance while seated thereon and to swing it to a stored position while keeping the seat attached to the stand. Huntley's invention has a different purpose. Huntley's design is suitable for the purpose for which it is intended. However, Huntley's invention is incapable of performing the movements necessary for the current invention.

The present invention is capable of performing the movements of Huntley's invention but adds additional utility in the form of a method for moving the seat from the facing the tree position to the facing away from the tree position.

### SUMMARY OF THE INVENTION

The primary objective of the current invention is to provide an improved method of moving the seat from the facing the tree position to the facing away position.

Another advantage is to provide the needed seat movement while the seat and hardware remain attached to the stand. Thus preventing parts from being dropped or lost.

Another advantage is to provide a method for a hunter to move the seat position easily and silently while remaining undiscovered by game, which may be in close proximity.

Another advantage is to reduce the number of moves a hunter must make in order to reposition the seat. Although the hunter is aloft, deer and other game can easily detect movement.

Another advantage is to enable the user to move the seat with one hand thereby leaving the other hand free for other use.

Another advantage is to improve safety. This is accomplished by eliminating detachable parts that may be dropped and reducing the amount of movement and out-of-balance situations.

The above and other advantages are carried out in one form by an improved method for moving the seat. The method employs a single seat, which is hinged or pivotally attached to a single supporting frame member and provided with a means to slide parallel with said frame member. The method of moving the seat is described in the following paragraph.

The user sits on the seat in the facing the tree position during ascension and descension. Upon reaching the desired vantage point, the user stands up and lifts the seat with one hand from the horizontal in-use position to a vertical non-use position.

The seat, attached to a single support rail, is then slid parallel to the supporting rail past the users body to its new position toward the tree. It is then returned to the horizontal in-use position. The occupant need only to turn around and sit, once the above movements have been performed.

A pivoting or hinged member attached to a sliding member is necessary to provide the described movements. These members are described in greater detail in the preferred embodiment.

### BRIEF DESCRIPTION OF THE DRAWINGS

A complete understanding of the present invention may be derived by referring to the detailed description of the preferred embodiment.

Referring now to the drawings

FIG. 1 shows the two tree stand platforms arranged on a tree in accordance with prior art. DETAIL 1 of FIG. 1 shows the location the parts affected by the current invention.

FIG. 2 is an isometric view of DETAIL 1.

FIG. 3 is a perspective view of the affected components.

FIG. 4 is a perspective view of an alternate design for a square geometric shape.

FIG. 5 shows the first movement required in a series to change the seat position.

FIG. 6 shows the second movement in the series.

FIG. 7 shows the third movement of the series.

FIG. 8 shows the seat in use at the new position.

### DETAILED DESCRIPTION OF PREFERRED EMBODIMENT

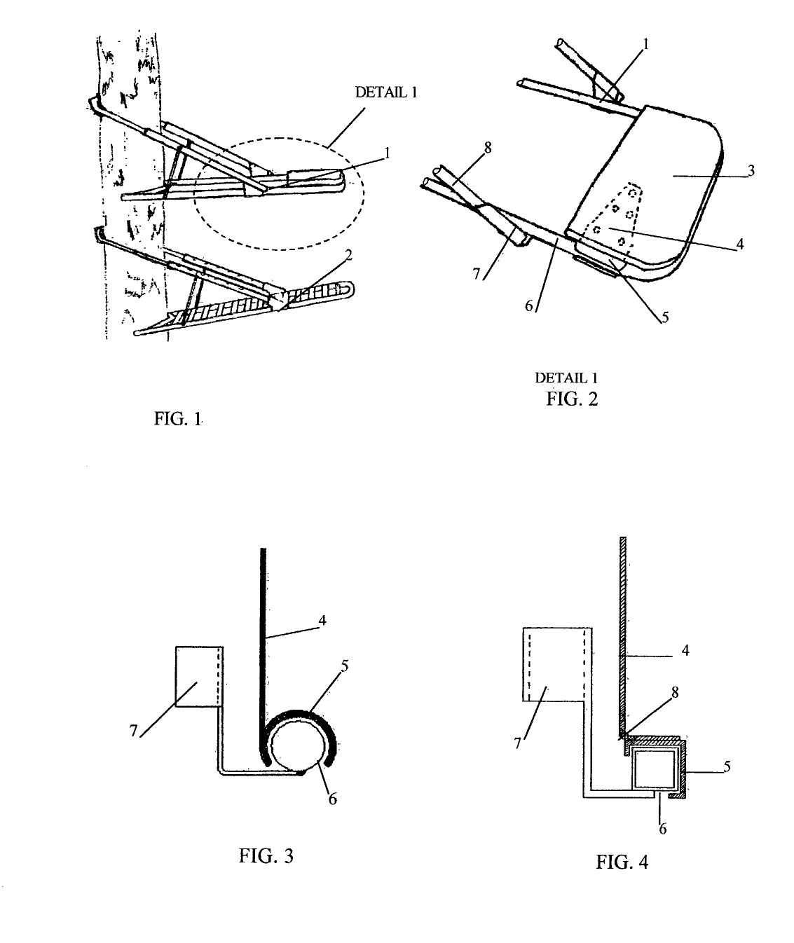

FIG. 1 shows a climbing tree stand with an upper 1 and lower 2 platform arranged on a tree in accordance with prior art. This arrangement is preferred for the ascension and descension modes and provides for sitting while facing the tree. The upper platform 1 embodies the current invention. DETAIL 1 of FIG. 1 encompasses the parts affected by the current invention. Any of a host of prior art devices are capable of securing platform 1 to the tree as shown and are therefore not further explained.

Still referring to FIG. 1, the user sits on platform 1 with his feet resting on platform 2. The platforms are alternately raised and lowered to ascend and descend the tree.

FIG. 2 shows the seat platform 1 DETAIL 1, which embodies the current invention. Seat 3 is constructed of wood or other suitably ridged material and has a width substantially greater that its length. Seat 3 also includes padding and a cloth cover on the upper side to improve comfort. One side of seat 3 is attached with suitable fasteners to seat bracket 4 through a plurality of holes. The opposite side of seat 3 rests on top of support rail 6. Support rail 6 is a tubular member formed in a u-shape. Sliding bracket 5 provides the attachment between seat bracket 4 and support rail 6. Sliding bracket 5 is welded to seat bracket 4 and partially encircles support frame 6. Sliding bracket 5 of the preferred embodiment is round, which enables it to pivot around support rail 6. Bracket 5 has a length sufficient to hold seat bracket 4 and seat 3 attached thereto perpendicular to support rail 6. Sliding bracket 5 further comprises a slot its entire length. The slot is sufficiently constructed and positioned to pass by support bracket 7 when the seat bracket 4 is in the vertical position as shown in FIG. 3. The sliding and pivoting motions are allowed by one part, bracket 5, in the preferred embodiment.

FIG. 4 is provided to illustrate an alternate design. This design, adapted for a square geometric shape, requires two parts as indicated by numbers 5 and 8. Bracket 5 is the sliding member and pivot 8 is the pivoting/hinge member.

Referring to FIG. 3, support bracket 7 is generally s-shaped and is welded to support rail 6 and adjustment leg 8. Support bracket 7 has a distal portion at the support rail 6 end; sufficient to allow sliding member 5, the seat bracket 4 and seat 3 attached thereto to pass by when in the vertical non-use/moving position.

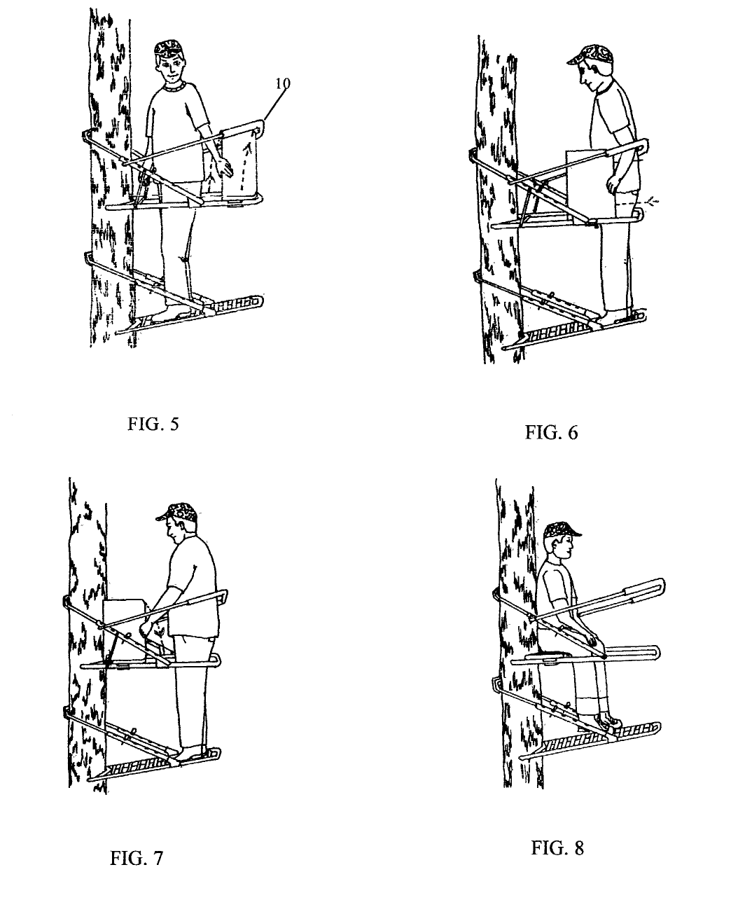

The invention is not limited by the design as shown and all other features can be changed as preferred provided the affected parts are capable of allowing the following movements in a series, described in reference to FIGS. 5, 6, 7 and 8. These FIGS. illustrate the movements of the seat using the new method, which is the current invention. FIGS. 5, 6, 7, and 8 also show a backrest/shooting rail 10, which is known in the art but is irrelevant to the current invention.

In FIG. 5 the user stands up and rotates the seat from the horizontal position to the vertical position. This is the first movement in the series.

In FIG. 6 the user slides the seat horizontally along the support rail past his body to its new position toward the tree. This is the second movement of the series.

In FIG. 7 the user rotates the seat back to its horizontal position. This is the final movement of the series. The user is then able to sit as shown in FIG. 8.

The above description is of a preferred embodiment of the present invention. The invention is not limited to the specific description and illustrations. In addition the method described herein need not be performed in the precise order described. Furthermore, many variations and modifications will be evident to those skilled in the art. Such variations and modifications are intended to be within the spirit and scope of the invention, as expressed in the following claims.

1. I claim the method of moving the seat on a tree stand from the facing the tree position to the facing away from the tree position. This method is defined in the following paragraph.
Upon reaching the desired vantagepoint, the user stands up and moves the seat by means of an attached pivot/hinge from a horizontal in-use position to a vertical non-use position. He then slides the seat, by means of an attached sliding member, parallel to the support member to which it is attached, past the users body to its new position. The seat is then returned to a horizontal in-use position by means of said pivot/hinge.

2. A tree stand using the method of claim 1 where the attached pivoting and sliding member is one part.

3. A tree stand using the method of claim 1 where the attached pivoting and sliding members are two or more parts.

4. A tree stand using the method of claim 1 where the pivoting and sliding members are detachable.
